(19) United States
(12) Patent Application Publication
(10) Pub. No.: US 2008/0022994 A1
(43) Pub. Date: Jan. 31, 2008

(54) Open pot gas fryer with corrugated bottom

(75) Inventors: Charles Milton Hutchinson, Shreveport, LA (US); Lamont E. Lackman, Keithville, LA (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: FRYMASTER L.L.C.

(21) Appl. No.: 11/881,968

(22) Filed: Jul. 30, 2007

Related U.S. Application Data
(60) Provisional application No. 60/834,324, filed on Jul. 28, 2006.

(51) Int. Cl. A47J 37/12; A47J 27/00

(52) U.S. Cl. 126/378.1; 99/403

(57) ABSTRACT

A frypot having a corrugated bottom portion. The corrugations project into an interior volume of the frypot, so that there are troughs disposed between the corrugations. During operation of the frypot, oil located in these troughs remains cooler, thus prolonging the life of the oil.

### BACKGROUND OF THE DISCLOSURE

1. Field of the Disclosure

The present disclosure relates to a gas fryer. More particularly, the present disclosure relates to a gas fryer that utilizes low volumes of cooking oil.

2. Description of the Related Art

In the field of deep fryers, it is desirable to minimize the amount of oil used to cook a food product, while maintaining full cooking capacity. This will help to reduce the operating cost of the fryer by reducing the volume of waste oil and lowering the cost of keeping the oil heated.

One of the factors that contributes to the amount of oil used is the food product debris that falls into the oil during fryer operation. The debris becomes charred and contributes to the decomposition of the oil. One way to alleviate this problem is to create a “cool zone,” a region of the cooking oil that is at a lower temperature than the areas where the cooking of the food product takes place. The debris can settle in this cooler region and not be exposed to the relatively higher heat of the remaining pot interior, which extends the usable oil life. One problem with currently available fryers that have cool zones, however, is that the cool zones are very deep, which consumes a high volume of oil. Additionally, these fryers typically have heating tubes or elements disposed within the frypot, which makes the frypot very difficult to clean.

An additional way to save on oil costs associated with these fryers is with a fryer that simply uses a low volume of cooking oil. Those fryers that do fit this description typically employ a heated bottom surface in the frypot. Often that surface is augmented with heated frypot side surfaces or with additional heating elements in the frypot cavity. Heating the oil in this manner can scorch the oil and is detrimental to oil life, and thus undesirable. These fryers can also be difficult to clean, due to the difficulty of accessing the areas around the heating tubes or heating elements.

Therefore, there is a need for a fryer that addresses the problems of currently available models.

### DETAILED DESCRIPTION OF THE INVENTION

The present disclosure features a fryer with a corrugated bottom that provides troughs of cool oil into which debris can settle and not be exposed to the relatively high heat of the remaining pot interior, thus extending the usable oil life. Burners are designed to provide heat to the crests of the corrugations. No heating elements protrude through the oil in the fryer, making the fryer easy to clean, and also saving oil volume. The lower oil volume affords the operator considerable savings by reducing the volume of oil waste, and by lowering utility costs as less oil needs to be heated to the cooking temperature.

A variety of burner types can be used in the fryer of the present disclosure. Additionally, the fryer can have a flat plate between the fryer tubes that provides a floor partially down the diameter of each tube. The fryer of the present disclosure can also have shields that provide an insulating air gap between the burner tube and the oil in the cooler area of the frypot. The frypot can also have a blower located at the front and/or rear of the frypot, to force combustion gases to the flue at the rear of the frypot.

### BRIEF DESCRIPTION OF THE DRAWINGS

FIG. 1 is a front view of a fryer according to the present disclosure;

FIG. 2 is a side cross-sectional view of the fryer of FIG. 1, shown across the indicated sectional line;

FIG. 3 is a side view of the fryer of FIG. 1;

FIG. 4 is a front cross-sectional view of the fryer of FIG. 1, shown across the indicated sectional line;

FIG. 5 is a bottom perspective view of the fryer of FIG. 1;

FIG. 6 is a top perspective view of the fryer of FIG. 1;

FIG. 7 is a bottom perspective view of the frypot of FIG. 1 with in-shot burners;

FIG. 8 is a front view of the frypot of FIG. 7;

FIG. 9 is a front perspective cross-sectional view of a frypot of a second embodiment of the fryer of the present disclosure; and

FIG. 10 is a front perspective cross-sectional view of a frypot of a third embodiment of the fryer of the present disclosure.

### DETAILED DESCRIPTION OF THE DISCLOSURE

The present disclosure features a fryer that comprises a frypot with a corrugated bottom surface that provides relatively cool regions in the troughs of the corrugations. Directed burners transfer heat through the peaks or crests of the corrugations and into the cooking oil. The cool regions along the bottom collect food product debris and prevent scorching of the debris, which could ruin the oil and shorten its life. Oil life is thus lengthened without use of a deep cold zone, which would require considerably more oil volume. The lower oil volume used affords the operator considerable savings by reducing the volume of waste oil, and by lowering utility costs as less oil is heated to the cooking temperature. The fryer also includes an open frypot with no submerged heating elements or tubes passing through the contained oil medium. The fact that there are no heating element or tubes disposed within the frypot makes it much easier to maintain and clean.

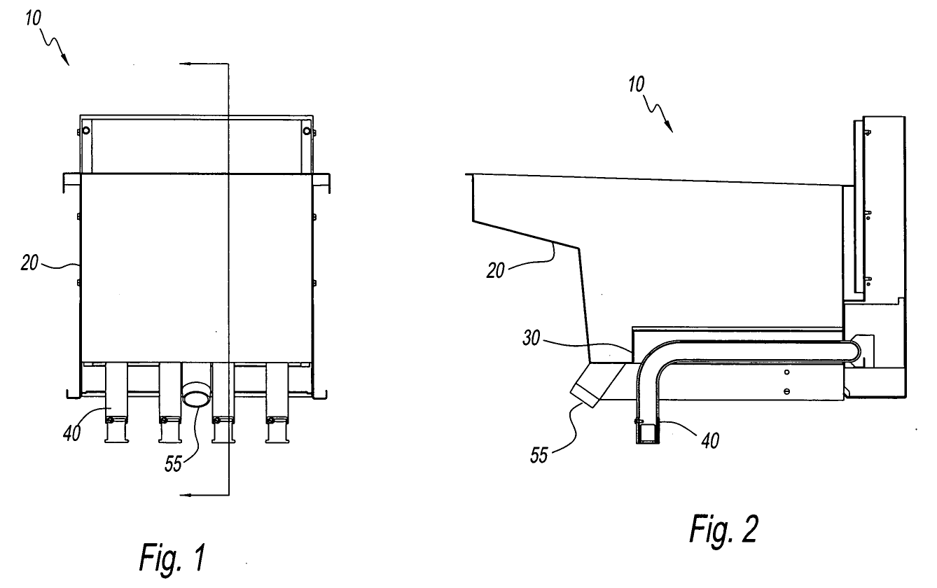

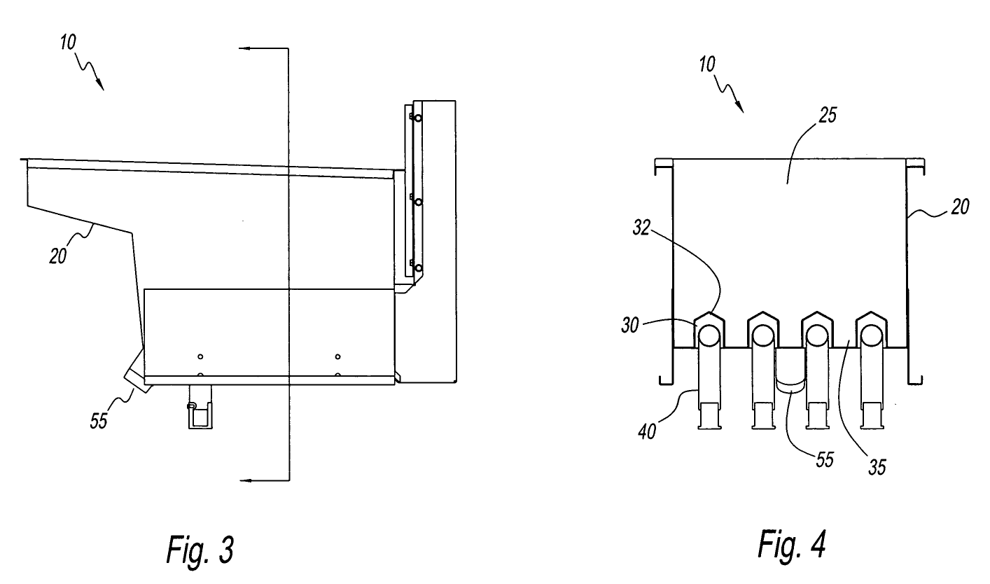

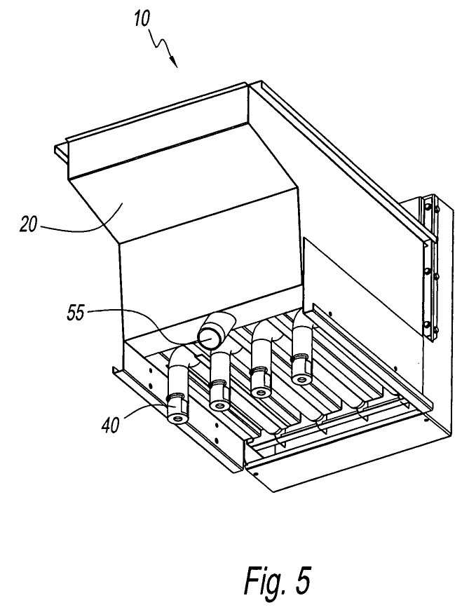

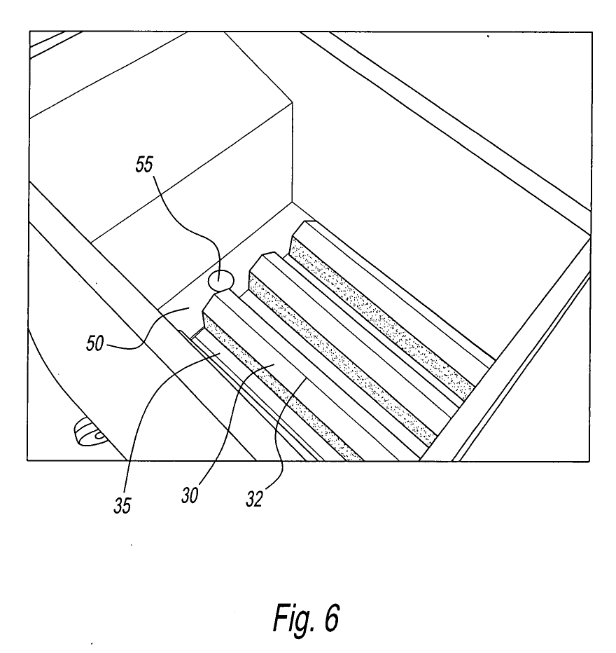

Referring to FIGS. 1 through 5, a fryer 10 of the present disclosure is shown. Fryer 10 has frypot 20 with interior volume 25. During fryer operation, interior volume 25 of frypot 20 is filled with a cooking medium, such as oil. The user would insert the food products to be cooked into the top of frypot 20.

Frypot 20 has a bottom with a number of corrugations 30 that define a plurality of cool zones or troughs 35, which are disposed between opposing peaks 32. A plurality of burners 40 are disposed under fryer 10 and frypot 20 so that the tops of burners 40 direct heat into peaks 32 of corrugations 30. In the shown embodiment, peaks 32 of corrugations 30 have an angular top that comes to a point. The present disclosure, however, contemplates the use of a number of shapes for corrugations 30, including, but not limited to, sinusoidal, semi-circular, or semi-oval. The shape of corrugations 30 that are best for a particular fryer will depend on the associated complexity and cost of the necessary tooling.

Referring to FIG. 6, the floor of fryer 10 is designed with a collector region 50 at one end of the bottom of frypot 20. Collector region 50 is fitted with a drain port 55 to allow frypot 20 to drain completely without oil being trapped between the corrugations. The floor of the frypot 20 can be slanted toward drain port 55 to facilitate draining. These features dramatically ease the cleaning process.

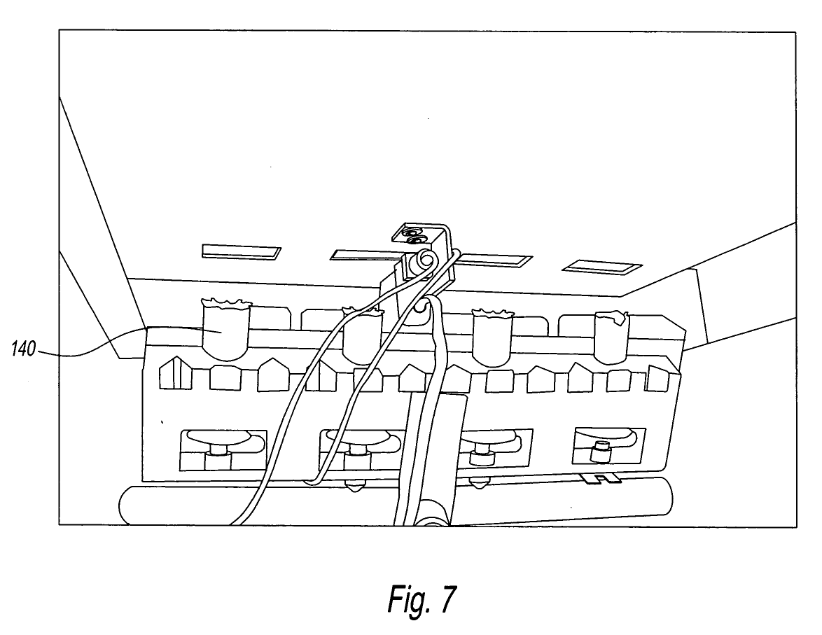

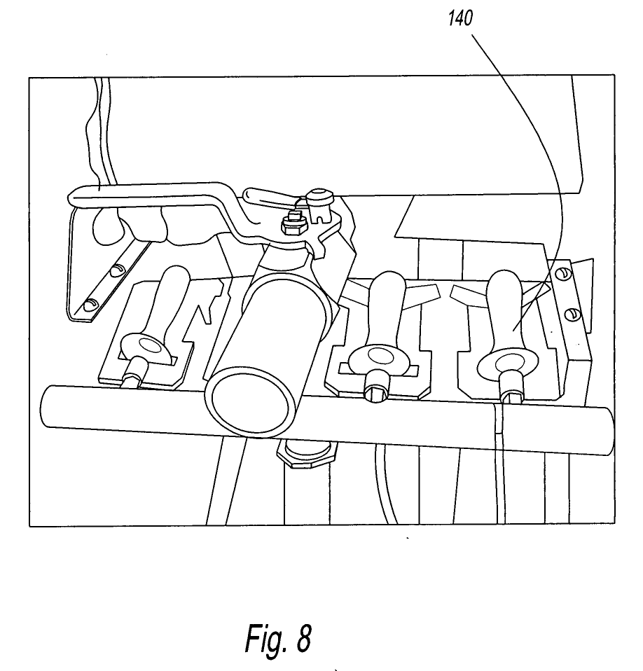

The present disclosure contemplates the use of several different kinds of burners in fryer 10. These include ribbon burners 40 that direct flame to the corrugation crests, shown in FIGS. 1 through 6. Additionally, as is shown in FIGS. 7 and 8, a plurality of in-shot burners 140 that direct conical flames toward the peaks 32 of corrugations 30 of frypot 20 can be used. Conventional tube inlet burners that will allow combustion products to migrate to the top of the crests can also be used in the fryer of the present disclosure, as can any other kind of burners that are suitable for this purpose.

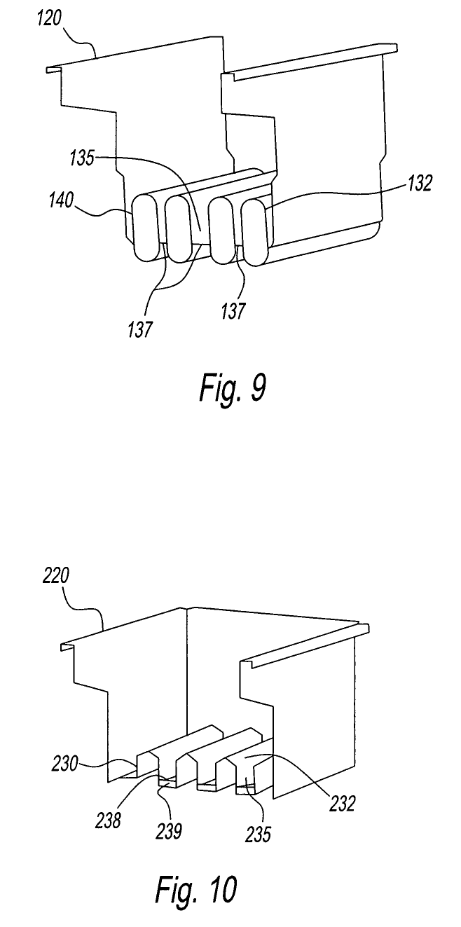

Referring to FIG. 9, a frypot using such conventional burner tubes is shown. Frypot 120 has a plurality of burner tubes 140. Burner tubes 140 have troughs 135 that are disposed between opposing peaks 132. Thus, during operation of the fryer, ignited combustion gases enter burner tubes 140, and migrate to peaks 132 of burner tubes 140, transferring heat to the oil in frypot 120, and leaving the oil located in troughs 135 relatively cool. Frypot 120 can also have a plurality of flat plates 137 positioned part way between burner tubes 140, resulting in a floor between each tube partially down the diameter of each tube. Burner tubes 140 remain complete, but have some percentage of their circumference outside the interior of frypot 120 and the remainder of their circumference inside frypot 120. This makes the frypot easier to clean than other standard tube fryers, and still provides the cool regions of the present disclosure.

Referring to FIG. 10, a third embodiment of a frypot of the present disclosure is shown. Frypot 220 has shields or covers 238 that protect troughs 235 of the corrugations 230 from the heat of the burner. Similarly to the frypots of previously discussed embodiments, burners (not shown) disposed below frypot 220 direct heat into peaks 232 of corrugations 230. Covers 238 follow the shape of trough 235, and are spaced away from trough 235 toward the burner body 240 so as to provide an insulating air gap 239 between cover 238 and the bottom of frypot 220. This would allow the oil residing in trough 235 to remain cooler for an even longer period than in the embodiment discussed above, thereby extending its life.

The fryer of the present disclosure can further have a blower either at the front or the rear of the fryer as part of the combustion system, designed so that accumulated flue gasses are ensured to pass to a flue collector at the rear of the fryer. This blower can comprise a tube that runs along the length of the pot. Such a design could offer higher thermal efficiency because it aids in the mixing of the combustion gases.

Many configurations for the fryer system are possible. There can be from one to twelve frypots within the fryer cabinet. Also, the fryer can optionally contain single or multiple built-in filter systems. These filter systems draw oil in from the frypot, remove any impurities, and recirculate the cleaned oil back into the frypot.

The present invention having been thus described with particular reference to the preferred forms thereof, it will be obvious that various changes and modifications may be made therein without departing from the spirit and scope of the present invention as defined in the appended claims.

What is claimed is:

1. A frypot which comprises a bottom portion having a corrugated portion disposed therein, wherein said corrugated portion comprises a plurality of troughs disposed between a plurality of opposing perturbations.

2. The frypot of claim 1, further comprising a drain port in said bottom portion.

3. The frypot of claim 2, wherein said corrugated portion is inclined toward said drain port.

4. The frypot of claim 1, further comprising a plurality of covers disposed within said troughs to form an air pocket between the bottom surface of said cover and the top surface of said corrugated portion.

5. A fryer, comprising:
a frypot which comprises a bottom portion having a corrugated portion disposed therein, wherein said corrugated portion comprises a plurality of troughs disposed between a plurality of opposing perturbations; and
a plurality of burners disposed about a bottom surface of said corrugated portion and a bottom interior surface of said frypot, wherein heat generated by said burners is substantially directed to said perturbations of said corrugated portion.

6. The fryer of claim 5, further comprising a plurality of covers disposed within said troughs to form an air pocket between the bottom surface of said shields and the top surface of said corrugated plate.

7. A fryer which comprises:
a frypot having an interior volume, and
a plurality of tube burners,
wherein said tube burners are disposed along the bottom of said frypot, so that at least a portion of said tube burners are disposed in said interior volume of said frypot, and
wherein said tube burners define a plurality of gaps disposed between said tube burners.

8. The fryer of claim 7, wherein at least a portion of said tube burners is disposed outside said frypot.
